(19) United States
(12) Patent Application Publication
(10) Pub. No.: US 2010/0004875 A1
(43) Pub. Date: Jan. 7, 2010

(54) Defect Inspection Method and Apparatus

(75) Inventors: Yuta Urano, Yokohama (JP); Toshifumi Honda, Yokohama (JP); Akira Hamamatsu, Yokohama (JP); Shunji Maeda, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi High-Technologies Corporation

(21) Appl. No.: 12/488,610

(22) Filed: Jun. 22, 2009

(30) Foreign Application Priority Data
Jul. 7, 2008 (JP) 2008-176456

(51) Int. Cl. G01N 21/88; G06F 19/00

(52) U.S. Cl. 702/40; 356/237.2

(57) ABSTRACT

In a detection step, light produced on a sample in plural directions are collectively detected using a plurality of detectors. Multidimensional features containing information about scattered light distributions are extracted based on a plurality of detector outputs obtained. The feature is compared with data in a scattered light distribution library thereby to determine the types and sizes of defects. In a feature extraction step, a feature outputted based on the magnitude of each of scattered light detected signals of scatterers already known in refractive index and shape, which are obtained in the detection step, is corrected, thereby realizing high precision determination.

### BACKGROUND OF THE INVENTION

The present invention relates to a defect inspection method and apparatus for inspecting micro defects existing in the surface of a sample to determine the type and size of each defect and outputting the same.

It has been practised to inspect defects existing in the surfaces of a semiconductor substrate and a thin-film substrate or the like on a line for manufacturing the semiconductor substrate and the thin-film substrate or the like with a view toward maintaining/improving the yield of each product. JP-A-9-304289 (patent document 1), JP-A-2006-201179 (patent document 2), etc. have been known as related arts. In order to detect micro defects, a laser beam focused to a few tens μm is applied onto the surface of a sample to collect and detect scattered light from the defects, thereby inspecting the defects each having a size ranging from a few tens nm to a few μm or more. There has thus been described a technique for detecting a component of each scattered light, which is emitted from each defect at a high angle and a component thereof emitted at a low angle and classifying the defects according to the ratio therebetween.

As a technique for determining distributions of scattered light based on defects existing in the surface of a sample and on the sample using a simulator and making it easy to set an inspection condition for maximizing the ratio between a detected output of the sample surface and a detected output of each defect, there has been known Japanese Patent No. 3300830 (patent document 3). Here, each of the scattered light distributions indicates the dependence of scattered light on its outgoing direction, i.e., the intensity of scattered light and the angular distribution of a polarized state. The patent document 3 refers even to the fact that the scattered light distributions determined by the simulator are compared with detected outputs corresponding to some of scattered light distributions obtained by performing switching between a plurality of filters thereby to determine the classification of defect types and the magnitude of each defect.

As methods each used for simulating each scattered light distribution by the micro shape of a sample surface, there have been known, in addition to a finite element method (FEM method) generally well known as electromagnetic field simulation, a finite difference time domain method (FDTD method), etc., a Discrete Dipole Approximation method (DDA method, non-patent document 1 (B. T. Draine and P. J. Flatau: “The Discrete-Dipole Approximation for Scattering Calculations”, J. Opt. Soc. Am. A, 11, pp. 1491-1499 (1994))) known as a scattering calculation method for arbitrary shapes on a flat substrate, a method provided by Bobbert, Vlieger et al. (BV method, non-patent document 2 (P. A. Bobbert and J. Vlieger, “Light Scattering by a sphere on a substrate”, Physica A, Volume 137, Issue 1-2, pp. 209-242 (1986)) known as a spherical particle calculation method on a flat substrate, etc.

### SUMMARY OF THE INVENTION

There has been a demand for high precision classification of various defects and high precision size measurement thereof upon a defect inspection used in a process for manufacturing a semiconductor or the like for early detection of process defective or failure factors of a manufacturing apparatus. The classification of concavo-convex defects by an intensity ratio in two directions between scattered light produced from defects, and the measurement of each defect size based on the amount of scattered light have heretofore been performed. Since, however, the scattered distribution/light amount depends on the shape and material of each defect and changes greatly and non-linearly, the accuracy of classification and size measurement for a plurality of defect types containing various shapes and materials was low.

Although a method for comparing scattered light distributions determined by a simulator with detected outputs is known as a technique for realizing high precision classification and size measurement, the related art has involved a problem that since there is a need to perform inspection plural times by switching of filters in order to obtain signals corresponding to a plurality of detection directions, the time necessary for the inspection becomes long. Further, there occurs a dissociation between each of actually-obtained detected outputs and each calculated value determined by simulation due to the influences of individual differences of an illumination section, a detection section, a signal processing section and the like, deviations/variations for adjustment, and errors caused by the accuracy of a simulation model and the like, it was difficult to obtain high precision classification/size determination performance by actual application of the above.

In order to solve the above problems, a summary of a representative or typical one of the inventions disclosed in the present application will be explained in brief as follows:

The present invention is characterized in that light produced on a sample in plural directions is collectively detected using a plurality of detectors, multidimensional features containing information about scattered light distributions is extracted based on a plurality of detector outputs obtained, and the feature is compared with data in a scattered light distribution library thereby to determine the types and sizes of defects. Here, the scattered light distribution library corresponds to a set of data corresponding to scattered light distributions of defects of plural types and sizes prepared in advance using simulation.

Preferably, in a step for extracting the feature, a feature to be outputted is corrected based on the magnitude of each of scattered light detected signals of scatterers already known in refractive index and shape, which are obtained in a step for performing the above detection.

Preferably, standard particles are used as the scatterers already known in the refractive index and shape.

Preferably, each of the scattered light distribution data is corrected based on the magnitude of each of scattered light detected signals of the scatterers already known in refractive index and shape, which are obtained in the detection step, the material of a film of a substrate surface or the thickness of the film of the substrate surface.

Preferably, the present invention comprises an input step for enabling a user to input each defect type intended for detection, and a display step for displaying the detected number of only defect types each designated as the defect type intended for the detection, of those determined to be defective in a step for performing the defect determination, or a distribution on each object to be inspected.

Preferably, a typical diagram of a shape of each of defects each belonging to the defect type designated in the input step, an enlarged image thereof by an electron microscope or the like, a scattered light distribution thereof or a feature corresponding to the scattered light distribution is displayed in the display step.

Preferably, the present invention comprises an input step for enabling a user to input each defect type intended for non-detection, and a display step for displaying the detected number of defect types other than defect types each designated as the defect type intended for the non-detection, of those determined to be defective in the defect determination step, or a distribution on each object to be inspected.

Preferably, a typical diagram of a shape of each of defects belonging to the defect type other than defect types intended for non-detection, designated in the input step, an enlarged image thereof by an electron microscope or the like, a scattered light distribution thereof or a feature corresponding to the scattered light distribution is displayed in the display step.

Preferably, in the display step, a determination condition and defect classification used to determine the type and size of each defect, and the result of size determination are displayed in association with each other, and reprocessing based on a determination condition after the determination condition has been changed by the input of the user and the acquired feature and data in the scattered light distribution library have been changed is further performed.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a schematic configuration diagram showing an overall configuration of an embodiment of the present invention;

FIG. 2 is a typical diagram illustrating a method for scanning a sample;

FIG. 3A is a configuration diagram depicting a configuration of a detection section;

FIG. 3B is an example in which a condensing system is configured by a reflection optical system based on an ellipsoidal mirror;

FIG. 3C is a configuration example illustrative of detection sections for gathering or collecting scattered light from a plurality of directions to form images on image sensors respectively;

FIG. 3D is a configuration example using a reflection optical system based on a Schwarzschild optical system;

FIG. 4A is a diagram for describing a method for displaying a detected angular range;

FIG. 4B-1 is one example of a detection system layout fit to detect foreign materials ranging from small to large sizes;

FIG. 4B-2 is an example in which a detection section for performing an omnidirectional detection at low angles and a detection section for detecting scattered light in a sample normal-line direction are laid out;

FIG. 5A is a configuration example which blocks or shields specularly reflected light by a spatial filter and detects only near scattered light as in specular reflection;

FIG. 5B is a configuration example of a detection system based on a schlieren method;

FIG. 5C is a configuration example in which ellipsometry is performed on light specularly reflected by a sample surface;

FIG. 6A is a diagram showing that an illumination intensity distribution at an illumination spot on a sample surface forms a Gaussian distribution in terms of the removal of variations in defect scattering intensity and measures against signal saturation;

FIG. 6B is a diagram showing that illumination spots are scanned in superimposed or convoluted form in terms of the removal of variations in defect scattering intensity and measures against signal saturation;

FIG. 6C is a diagram illustrating one example of a signal where a signal corresponding to the same defect is detected plural times in terms of the removal of variations in defect scattering intensity and measures against signal saturation;

FIG. 6D is a diagram showing a method for measuring a defect spatial spread with a high degree of accuracy in terms of the removal of variations in defect scattering intensity and measures against signal saturation;

FIG. 7A is a diagram for describing a sample for apparatus calibration;

FIG. 7B is a diagram showing a histogram of a detected signal of a standard particle having a given particle diameter;

FIG. 7C is a graphic representation of one example illustrative of a feature set every feature item;

FIG. 7D is a graphic representation of one example illustrative of correction coefficients of a feature set every feature item;

FIG. 8A is a typical diagram showing a configuration of a scattered light distribution library held in a storage part contained in a defect type/size determination unit;

FIG. 8B is a diagram showing an example of a continuous scattered light distribution of defects corresponding to respective illumination conditions;

FIG. 8C is a diagram showing parameters indicative of illumination and detection conditions;

FIG. 9A is a diagram illustrating a display screen indicative of a model of each individual defect, a scattered light distribution thereof and a feature thereof;

FIG. 9B is a diagram showing an example of a display screen indicative of scattered light distribution data about size ranges selected for a specific defect type;

FIG. 10A is a first diagram showing a method for creating a scattered light distribution library;

FIG. 10B is a second diagram illustrating a method for creating a scattered light distribution library;

FIG. 10C is a third diagram depicting a method for creating a scattered light distribution library;

FIG. 11A is a diagram showing a substrate refractive index estimating method for performing high precision defect type classification and size determination;

FIG. 11B is a block diagram illustrating a method for correcting a scattered light distribution library and a method for adding data;

FIG. 12A is a diagram for describing a method for determining defect types and defect sizes, based on a feature extracted by a feature extraction unit;

FIG. 12B is a diagram for describing a method for narrowing down candidate defect data intended for feature comparison;

FIG. 13A is a diagram showing an input/output flow where a defect type intended for inspection is designated;

FIG. 13B is a diagram illustrating an input/output flow where a defect size intended for inspection is designated;

FIG. 14A is a diagram showing an input/output flow where a defect type excepted from those intended for inspection is designated;

FIG. 14B is a diagram showing an input/output flow where a defect size intended for inspection is designated;

FIG. 15 is a flowchart illustrating the flow of inspection;

FIG. 16 is a typical diagram of a GUI for setting an inspection process, defects intended for inspection and sizes intended for inspection;

FIG. 17A is a typical diagram of a GUI for displaying a result of inspection;

FIG. 17B shows an example of a GUI for performing the setting of defect type and size determination processing conditions and the display of a processing result after a target sample has been scanned at least once or more;

FIG. 18A is a configuration diagram of an illumination section, showing a method for illuminating and detecting a plurality of mutually different positions on a sample;

FIG. 18B is a configuration diagram of a detection section, showing a method for illuminating and detecting a plurality of mutually different positions on a sample;

FIG. 19A is a diagram showing a concrete example of a method for switching illumination conditions; and

FIG. 19B is a diagram illustrating an example of a temporal relationship among a pulse illumination output, an illumination condition, a detection condition and ON/OFF of exposure of each detector.

### DESCRIPTION OF THE EMBODIMENTS

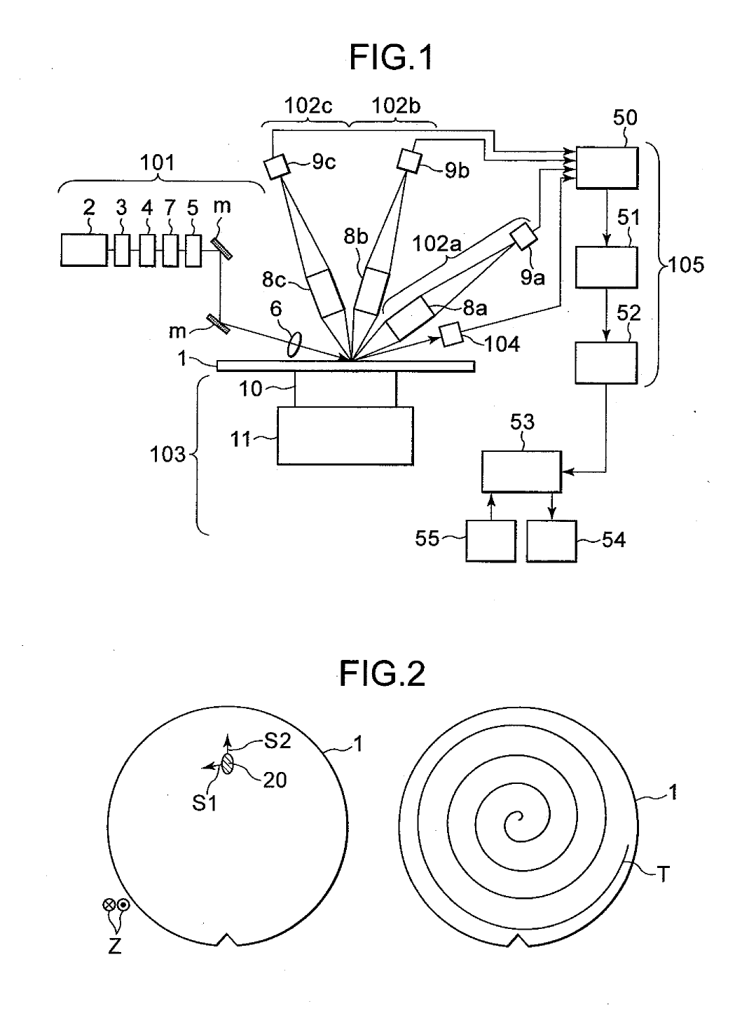

A configuration of an embodiment of the present invention will be explained using FIG. 1. The present embodiment is configured using suitably an illumination section 101, a detection section 102 (102a, 102b and 102c), a stage 103 capable of placing a sample 1 thereon, a signal processing section 105, an overall control unit 53, a display unit 54 and an input unit 55. The signal processing section 105 has a defect determination unit 50, a feature extraction unit 51 and a defect type/size determination unit 52. A specular reflection detecting unit 104 is provided as needed for the purpose of a large area defect inspection or sample surface measurements and the like.

The illumination section 101 is configured using suitably a laser light source 2, an attenuator 3, a polarizing device or element 4, a beam expander 7, an illumination distribution control element 5, a reflection mirror m and a condensing lens 6. Laser light emitted from the laser light source 2 is adjusted to a desired beam intensity by the attenuator 3, adjusted to a desired polarization state by the polarizing element 4, adjusted to a desired beam diameter by the beam expander 7, followed by being illuminated on an inspected area of the sample 1 via the reflection mirror m and the condensing lens 6. The illumination distribution control element 5 is used to control an intensity distribution of illumination on the sample 1. Although such a configuration that the illumination section 101 applies light from the direction inclined or slanted with respect to the normal of the sample 1 is shown in FIG. 1, such a configuration that light is applied from the direction orthogonal to the surface of the sample 1 may be adopted. Illumination optical paths of those referred to above may be set switchably by switching means.

As the laser light source 2, there is used one which in order to detect each small defect near the surface of the sample, causes an ultraviolet or vacuum ultraviolet laser beam to oscillate having a short wavelength as a wavelength hard to penetrate into the sample and provides a high output of 1 W or more. In order to detect each defect lying inside the sample, there is used one in which a visible or infrared laser beam is caused to oscillate at a wavelength easy to penetrate into the sample. The laser light source may suitably be selected as a light source for oblique illumination or epi-illumination as needed.

The stage 103 has a translational stage 11, a rotating stage 10 and a Z stage (not shown). FIG. 2 shows the relationship between an illumination area (illumination spot 20) lying on the sample 1 and the direction of scanning by movements of the rotating stage 10 and the translational stage 11, and a trajectory of a radiation or illumination field 20 plotted on the sample 1. FIG. 2 shows the shape of an illumination field 20 shaped in the form of an ellipse long in one direction and short in the direction orthogonal to the one direction by illumination distribution control or oblique illumination at the illumination section 101. The illumination field 20 is scanned in a circumferential direction S1 of a circle with the rotational axis of the rotating stage 10 as the center by the rotational movement of the rotating stage 10 and scanned in a translational direction S2 of the translational stage 11 by the translational movement of the translational stage 11. The illumination section 101 is configured in such a manner that the longitudinal direction of the illumination spot 20 becomes parallel to the scan direction S2 and the illumination spot 20 passes through the rotating axis of the rotating stage 10 by the scanning in the scan direction S2. The movement of the Z stage corresponds to the height of the sample 1, that is, the movement of the surface of the sample 1 in the direction of the normal thereto. While the sample is rotated once by the scanning in the scan direction S1 under the above configuration, the scanning in the scan direction S2 is performed by a distance less than or equal to the longitudinal length of the illumination spot 20. Thus, the illumination spot plots a spiral trajectory T so that the entire surface of the sample 1 is scanned.

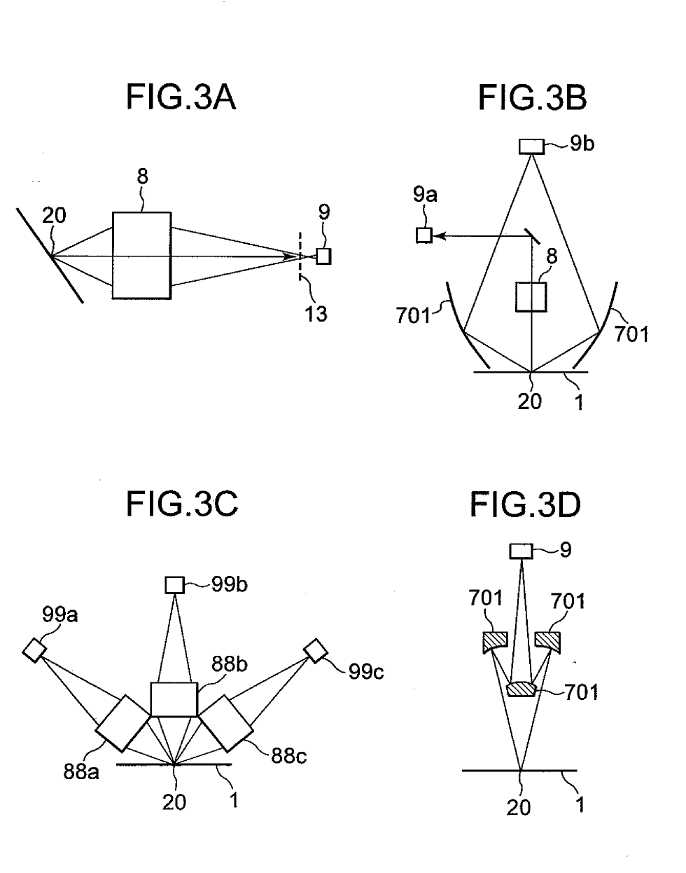

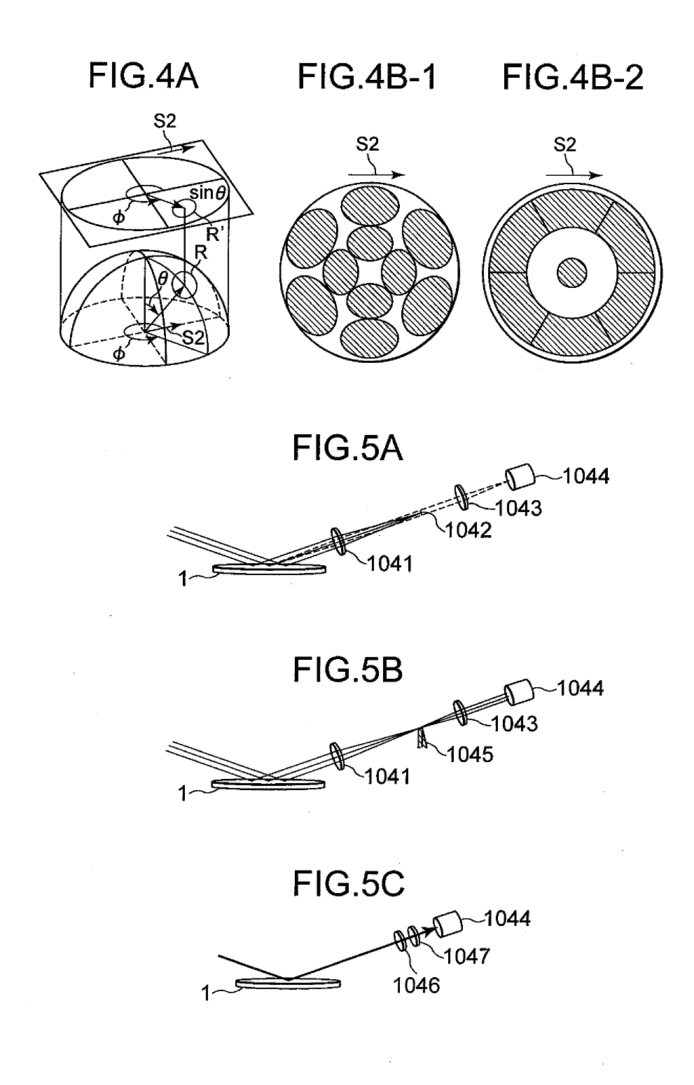

The detection units 102a, 102b and 102c are configured so as to gather and detect scattered light produced at orientations and elevation angles different from one another. A configuration of the detection unit 102a is shown in FIG. 3. Since components or constituent elements of the detection units 102b and 102c are common to the detection unit 102a, their explanations are omitted. In order to detect scattered light in a wide angular range, a plurality of detection units different from one another in the direction of detection may be disposed in large numbers as will be described later in FIG. 4 without limiting the layout or location of the detection unit to the detection units 102a, 102b and 102c shown in FIG. 1. The detection unit 102a is configured using a condensing system 8, a polarizing filter 12 and a sensor 9 suitably. An image of the illumination spot 20 is focused or formed on a light-detecting surface of the sensor 9 or in the neighborhood thereof by the condensing system 8. Suitably laying out a field stop having a suitable diameter at its image-forming position makes it possible to remove and reduce background light produced from each position other than the illumination spot. The polarizing filter 13 is attachable onto and removable from the optical axis of the image-forming or condensing system 8 and rotatable around the optical axis. The polarizing filter 13 which functions as an analyzer is used with the aim of reducing scattered light components due to sample roughness or the like that leads to noise. As the polarizing filter 13, there is used a wire grid polarizing plate or a polarizing beam splitter high in transmissivity and extinction ratio even at a short wavelength of ultraviolet light or the like. As the wire grid polarizing plate, there is known one having a structure in which a thin film of a metal such as aluminum or silver is micro-fabricated in stripe form. In order to make it possible to detect weak light scattered by foreign materials, photomultiplier, an avalanche photodiode, a semiconductor optical detector coupled to an image intensifier, or the like is suitably used as the sensor 9. It is desirable that an ultra bialkali type or a super bialkali type high in quantum efficiency is used as the photomultiplier for realizing high sensitivity and high precision.

An example in which a condensing system is configured by a reflection optical system based on an ellipsoidal mirror, is shown in FIG. 3B. In a condensing system 701, a first focal position of an ellipse is taken as the position where illumination light is applied, and a second focal position thereof is placed in a light-detecting surface of a sensor 9b. The condensing system 701 collects or gathers scattered light with a high NA containing an angle shallow with respect to a wafer surface and introduces the same to the corresponding sensor. In addition to the above, the condensing system 701 has a detection unit for detecting upward scattered light, which comprises a condensing system 8 and a sensor 9a, and is capable of detecting scattered light in plural directions simultaneously. FIG. 3C is a configuration example illustrative of detection units which collect scattered light from plural directions and form images on image sensors respectively. Condensing image-forming systems 88a, 88b and 88c focus scattered light in plural directions different in orientation and elevation angle on their corresponding image sensors 99a, 99b and 99c as images. The scattered light on the surface of the sample are detected as the images and subjected to image processing, thereby making it possible to detect defects produced in circuit patterns at a semiconductor wafer and a mask formed with the circuit patterns. This is therefore effective at inspecting a sample formed with patterns. As the image sensor, there is used a CCD, a linear array sensor or two-dimensional array sensor configured by CMOS, a high-sensitive image sensor in which an image intensifier is coupled to these, or a multi-anode photomultiplier. FIG. 3D is a configuration example using a reflection optical system based on a Schwarzschild optical system. This is suitable for the focusing of the scattered light onto a sensor 9 as images where illumination is done at a short wavelength of 200 nm or less.

The defect determination unit 50 determines each defect-existing location on the surface of the sample, based on the scattered light signal detected by the detection section 102. The feature extraction unit 51 extracts a feature with respect to the location determined to be a defect. The feature corresponding to each detected defect is inputted to the defect type/size determination unit 52, where a defect type of each detected defect and its defect size are determined based on the feature. Results of determination of the defect type and size are associated with the position (defect coordinate) of each defect on the sample surface and transmitted to the overall control unit 53, which in turn are outputted from the display unit 54 in the form to be confirmable by an apparatus user.

A description will be made of a method for determining each defect-existing location or spot on the sample surface, based on the scattered light signal at the defect determination unit 50. While the illumination spot 20 scans on the sample surface, the detection section 102 outputs a scattered light signal based on small roughness of the sample surface. When the illumination spot 20 passes through the corresponding defect-existing location on the sample surface, the detection section 102 outputs a defect scattered light signal in addition to the scattered light signal based on the small roughness. Thus, the small-roughness scattered light signal slow in temporal variation is removed and a defect signal that rises momentarily is extracted, so that defect determination is done. Described concretely, the signal outputted from the detection section 102 is converted to a voltage signal having appropriate magnitude by an amplifier, which in turn is converted to a digital signal by an AD converter, after which the signal is caused to pass through a highpass filter or bandpass filter that cuts a small roughness signal having a low frequency component and passes through a frequency band for the defect scattered light signal, whereby only the defect scattered light signal is extracted. Since the scattered light signal subsequent to having passed through the highpass filter or bandpass filter also contains noise such as shot noise of each scattered light, electric noise of a signal processing circuit and the like here, only a signal higher than a predetermined threshold value is determined and extracted as the defect scattered light signal by threshold processing. In order to avoid aliasing by AD conversion, a lowpass filter is provided at a stage prior to the AD converter as needed. The output of the detection section 102 is divided into two systems, one of which is used for the extraction of the defect scattered light signal and the other of which is caused to pass through the lowpass filter passing only the small roughness scattered light signal after AD conversion, thereby making it possible to take out or extract the defect scattered light signal and the small roughness signal in parallel simultaneously. Since the shot noise of the scattered light is proportional to the square root of the magnitude of the small roughness signal, the determination or decision threshold value used for the defect determination is taken as a variable threshold value changed according to the square root of the magnitude of the small roughness signal, thereby making it possible to detect each defect with high sensitivity while avoiding that noise is misjudged to be a defect.

The relationship between angular components of the scattered light detected by the detection units 102a, 102b and 102c is shown using FIG. 4B. FIG. 4A is a diagram for describing a method for displaying each detected angular range. FIG. 4A shows a hemisphere whose equatorial plane corresponds to the surface of the sample and whose direction of the normal to the sample surface is taken as the zenith. An azimuth angle (longitude) with a scan direction S2 as a standard or reference is assumed to be φ, and the angle formed from the zenith is assumed to be θ. The angular range detected by each of the detection units 102a, 102b and the like is defined by a region R lying on the hemisphere. Ones each obtained by parallel-projecting the range onto the surface parallel to the equatorial plane and displaying the same correspond to FIG. 4B-1 and FIG. 4B-2 The angular range detected by each of the detection units 102a, 102b and the like is indicated by hatching. As shown in FIG. 4B-1 and 4B-2, a plurality of detection units are provided to cover a wide angular range, thereby making it possible to detect various types of defects. Since angular distributions of defect scattered light differ according to defect types and sizes, scattered light intensities at various angles are simultaneously detected by a plurality of detection systems and processed by a signal processing unit to be described later, so that the classification of the defect types and the estimation of the defect sizes can be performed with a high degree of accuracy. FIG. 4B-1 is one example of a detection system layout fit to inspect foreign materials ranging from small to large sizes. Scattered light of each small foreign material comes out strong at a low angle where P-polarization illumination is made thereto. Detecting low-angle scattered light components in all directions enables the detection of submicroscopic defects. Further, a dent defect such as COP (Crystal Originated Particle) at which high-angle scattered light comes out strong can also be inspected with high sensitivity by detecting each scattered light component that comes out at a high elevation angle. Furthermore, a plurality of detectors are respectively disposed in θ and φ directions thereby to make it possible to take or capture the characteristics of scattered light distributions different according to defects. FIG. 4B-2 is an example in which a detection unit for performing an omnidirectional detection at low angles and a detection unit for detecting each scattered light in the direction of the normal to the sample are provided. Using the ellipsoidal mirror with the position of the illumination spot taken as a focal point on one side thereof as the condensing system 8 as shown in FIG. 3B makes it possible to collect or gather scattered light in all directions in a specific θ angular range. Further, spatial filter means or optical-path branching means is provided in the optical path of the condensing system and a plurality of detectors corresponding thereto are provided thereby to make it possible to collectively detect scattered light in plural directions. By capturing the scattered light in the wide angular range even in any configuration, the scattered light different in outgoing direction according to the defects can be detected and various defects can be detected in robust form. Further, scattered light components in plural directions are individually detected thereby to make it possible to perform defect classification and size determination by comparison with a scattered light distribution library to be described later.

The defect scattered light distribution depends on the material (refractive index), shape and size of each defect. When illumination light is made launched from an oblique direction, the scattered light is shifted forward as the transverse size (defect size in the in-plane direction of the sample surface) of each defect becomes larger as well known. The terms “forward” described herein indicates the direction close to the direction of specular reflection of illumination by the sample surface. When the transverse size of the defect is extremely larger than an illumination wavelength (the transverse size is ten or more times the wavelength), most of scattered light components concentrate in the neighborhood of the specularly reflected light. Therefore, the detection of each light scattered in the neighborhood of the specular reflection is effective at capturing the defect scattered light distribution large in transverse size.

FIG. 5 shows a configuration example of the specular reflection detecting unit 104. FIG. 5A is a configuration that blocks or shields specularly reflected light by a spatial filter and detects only scattered light extremely close to the specularly reflected light. A lens 1041 is provided in such a manner that its optical axis coincides with the optical axis of the specularly reflected light by the sample 1, of the illumination light produced by the illumination section 101 and its focal point coincides with its corresponding illumination spot 20. The light that has been emitted from the illumination spot 20 and has passed through the lens 1041 becomes parallel light, and the specularly reflected light is shielded by a light-shielding filter 1042 provided on the optical axis of the lens 1041. The light that has been emitted from the illumination spot 20 and polarized with respect to the specularly reflected light passes through a position spaced from the optical axis by a distance corresponding to its polarized angle. Thus, only optical components at an angle or more at which the polarized angle corresponds to the magnitude of the light-shielding filter penetrate the light-shielding filter and are gathered by a lens 1043, followed by being detected by a sensor 1044. The intensity of each scattered light component close to the specularly reflected light is measured by the above configuration. Incidentally, a distribution of scattered light close to the specularly reflected light can be measured by placing a plural-pixels dividing sensor such as a 4-division sensor immediately after the light-shielding filter 1042. FIG. 5B is an example of a configuration of a detection system based on a schlieren method. FIG. 5B shows a configuration in which the light-shielding filter 1042 is replaced with a knife edge 1045 with respect to FIG. 5A. Slight polarization or diffusion of the specularly reflected light, which occurs due to each defect having a magnitude equal to or greater than the size of an illumination spot can be captured from the magnitude of 1/10 of the size of the illumination spot as a change in the intensity detected at the sensor 1044. FIG. 5C is a configuration example in which ellipsometry is performed on light specularly reflected by a sample surface. Although various methods are known for the ellipsometry, such a configuration that a phaser 1046 and an analyzer 1047 are rotated at rotational speeds different from each other and the intensity of transmitted light is detected by the sensor 1044 is shown herein. Since the polarized state of the specularly reflected light is perfectly measured by this configuration, a complex index of refraction of the sample surface and its thickness can be calculated based on a change in the polarized state before and after the reflection of illumination light determined therefrom by the sample surface.

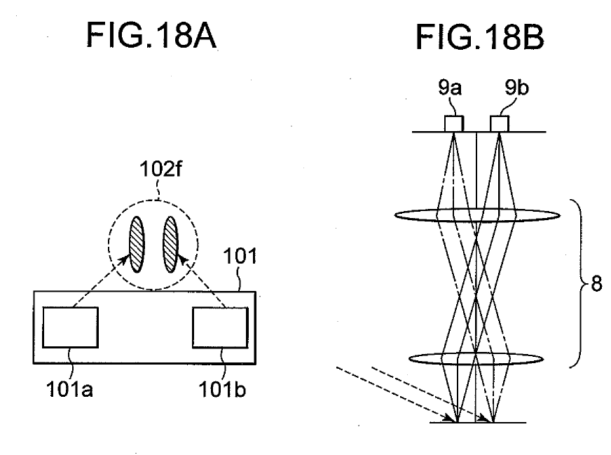

Next, configuration examples of an illumination section 101 and a detection section capable of collectively acquiring or capturing defect scattered light signals placed under a plurality of illumination conditions different from one another by illuminating a plurality of mutually different positions on a sample are shown in FIG. 18. As shown in FIG. 18A, the illumination section 101 is comprised of illumination units 101a and 101b that perform illumination under a plurality of illumination conditions different from one another. The illumination units 101a and 101b are realized by causing an optical path extending from a common light source to branch off to provide a plurality of optical paths or providing optical paths for introducing respective illumination light emitted from a plurality of mutually-different light sources onto the sample. Illumination is done such that illumination spots do not overlap each other within a field of view 102f of a condensing system 8 by the illumination units 101a and 101b. FIG. 18A has typically shown by way of example, the example in which the respective illumination in the illumination directions different from each other are performed. As shown in FIG. 18B, images are formed such that illumination spots do not overlap each other on an image-forming surface. They are detected by detectors 9a and 9b respectively. With the above configuration, scattered light generated corresponding to a plurality of mutually-different illumination conditions are individually detected by the detectors 9a and 9b respectively. Thus, illumination spots associated with a plurality of illumination units are spatially separated from one another and their illumination regions or areas are individually detected by a plurality of detectors respectively, so that a plurality of scattered light distributions generated corresponding to a plurality of mutually-different illumination conditions are individually detected every detector.

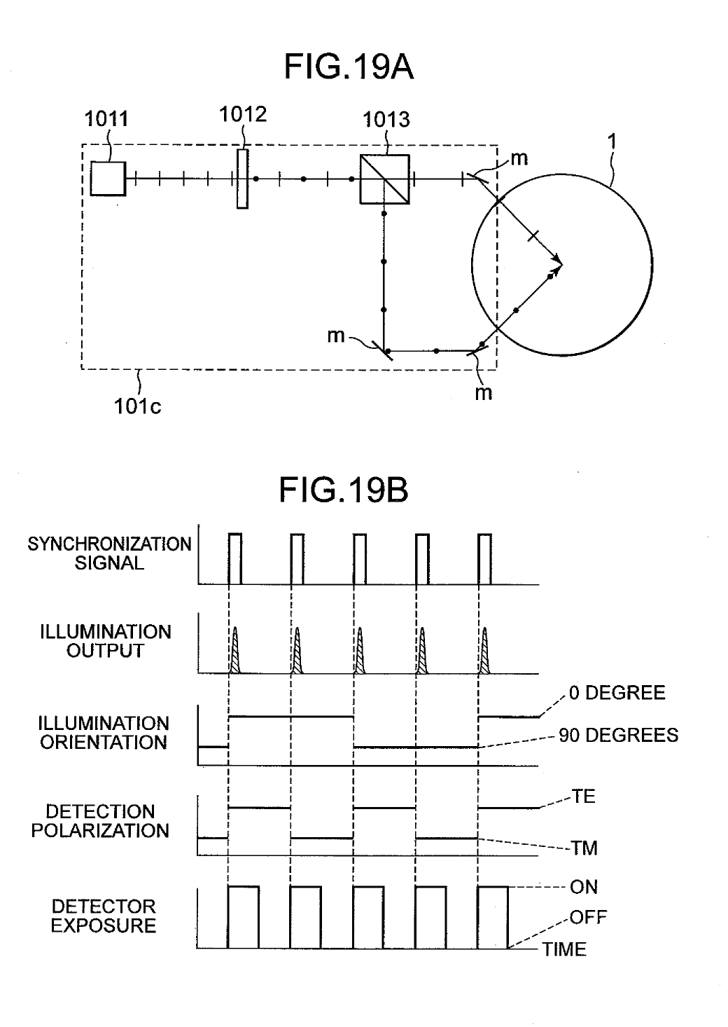

A concrete example of a method for temporally switching illumination and detection conditions will be explained using FIG. 19. FIG. 19A shows a specific example of a method for performing switching between illumination conditions. As a light source 101, a pulse laser or a flash lamp is used which performs strobe-light emission periodically. As a polarizing modulation element or device 1012, there is used one which temporally changes a given phase difference in matching with the cycle of strobe-light emission of a light source or the cycle equal to an integral multiple thereof, such as an electro-optic element or device, a magneto-optic device, an acousto-optic device, a liquid crystal device or the like. A polarized state of periodic pulse light emitted from the light source is temporally switched by the polarizing modulation device 1012. An optical path is caused to branch off according to the polarized state by a polarization beam splitter 1013 thereby to temporally switch the optical path along which the pulse light passes. Thus, the same spot is illuminated while the polarized state, the direction of illumination, an illumination incident angle and the like are being switched temporally. A spatial light modulating element or device is provided between images even on the detection side, and a polarization distribution, a phase distribution and an intensity distribution of transmissive light are switched temporally, thereby making it possible to switch optical conditions to be detected temporally. As the spatial light modulating device c, there is used a liquid crystal device, an electro-optic device, a magneto-optic device, an acousto-optic device, a micro mirror device, a GLV (Grating Light Valve), a mechanically-driven light-shielding plate or the like.

An example of a temporal relationship among a pulse illumination output, an illumination condition (illumination direction or orientation as an example), a detection condition (polarization component to be detected as an example) and ON/OFF of exposure of each detector is shown in FIG. 19B with the horizontal axis as a time base. With a synchronization signal outputted from the drive unit of the stage section 103 as the reference, illumination emits light on a pulse basis to switch illumination orientations and detected polarized light. Thus, scattered light distributions relative to respective pulse light are respectively individually detected by a single detector. Assuming that the illumination condition is N (where N=1, 2, . . . ) and the detection condition is M (where M=1, 2, . . . ), detected signals corresponding to the combinations of optical conditions of N×M at maximum are obtained. With the configurations shown in FIGS. 18 and 19 as described above, scattered light detected signals placed under a plurality of illumination conditions and detection conditions different from one another can be collectively detected by one sample scanning.

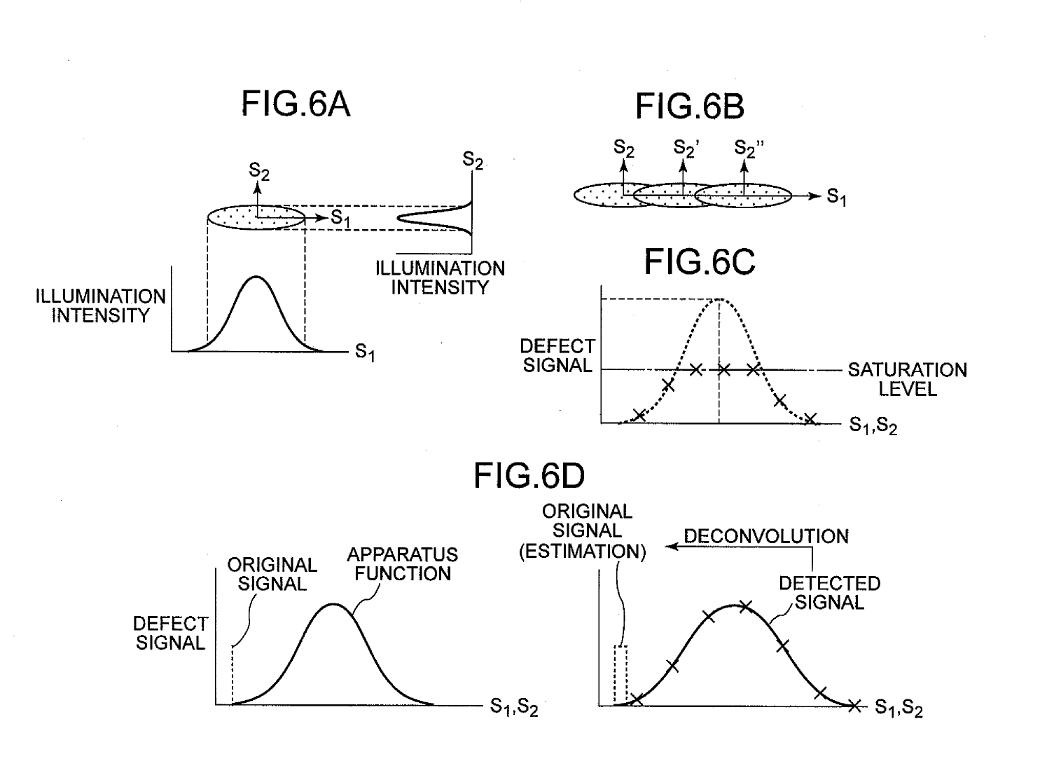

The removal of variations in defect scattered intensity due to the intensity distribution of each illumination spot and measures against signal saturation will be explained using FIGS. 6A, 6B and 6C. In order to gather a beam emitted from a light source with high efficiency and form each micro illumination spot on a sample surface, one that emits a Gaussian beam is substantially used as the light source 2. Thus, an illumination intensity distribution at an illumination spot 20 on the sample surface forms a Gaussian distribution (FIG. 6A). When the amount of scanning S1 per rotation for S2 scanning is smaller than the length in an S1 direction of the illumination spot, the illumination spot 20 is scanned in the S1 direction in convoluted or superposed form as shown in FIG. 6B. Since, at this time, the same defect is scanned plural times while the position thereof relative to the illumination spot 20 is being changed, signals for the same defect are detected plural times. Thus, when the signals are plotted with S1 as the horizontal axis, a Gaussian distribution is drawn or plotted similarly to the illumination intensity distribution. Even as to a S2 direction, signals are sampled in time shorter than the time at which illumination spots pass through a defect, upon scanning in the S2 direction, so that signals detected plural times from the same defect similarly plot or draw a Gaussian distribution in the same manner as the illumination intensity distribution in the S2 direction. One example illustrative of signals where signals for the same defect are detected plural times is shown in FIG. 5C. Points indicated by × marks correspond to actually obtained signals respectively. This graph shows a signal-saturated example because signals obtained when a defect passes through the central part of the Gaussian distribution, i.e., the central part of the illumination intensity distribution exceed a saturation level of each detector. Even when no saturation occurs, each defect detected signal has variations that depend on the relative position through which the defect has passed, with respect to the illumination spot scanning. Since the original Gaussian distribution (similar to the illumination intensity distribution) is already known in such a case, the original defect signal (indicated by a dotted line in FIG. 6C) can be restored from the obtained plural signals. The variations in the defect signal due to the illumination intensity distribution and the influence of the signal saturation can be suppressed by such a method. Incidentally, the illumination intensity distribution needs not to be limited to the Gaussian distribution, and a substantially uniform illumination intensity distribution may be formed using homogenizer or the like.

Next, a method for measuring a defective spatial expansion or spread with a high degree of precision is shown using FIG. 6D. The size of each illumination spot is as large as a few tens of μm to ensure a detection speed. In contrast, a defect can be assumed to be a point having no area. There is however a case where as to the defects each having the transverse size (of a few μm or more) equal to ten or more times the wavelength as mentioned above, information obtained from the scattered light distribution are few because the scattered light concentrates substantially in the specularly-reflected direction neighborhood, and their classification becomes difficult. Making good use of information about what times signals are detected over sampling upon scanning is effective for such classification and size measurements. Since, however, a profile of a detected signal takes such a shape that an apparatus function is convolved onto the original signal (spatial spread of defect), the resolution for measurement of the defect spatial spread is limited according to the apparatus function. Therefore, a profile (indicated by a dotted line in FIG. 6C) in which deconvolution based on an apparatus function is performed on a profile of a detected signal is assumed to be an index, thereby making it possible to perform a high resolution measurement of each defect spatial spread. Here, the apparatus function indicates the spread of signals by illumination, detection and processing systems. In the present apparatus configuration, the apparatus function becomes equal to the illumination intensity distribution. When the response speeds of the detector and processing system are slow relative to signal sampling, the round of each signal due to it is reflected on the apparatus function. The apparatus function can be actually measured by measuring a detected signal profile of defects each (assumed to be a point) having no spatial spread.

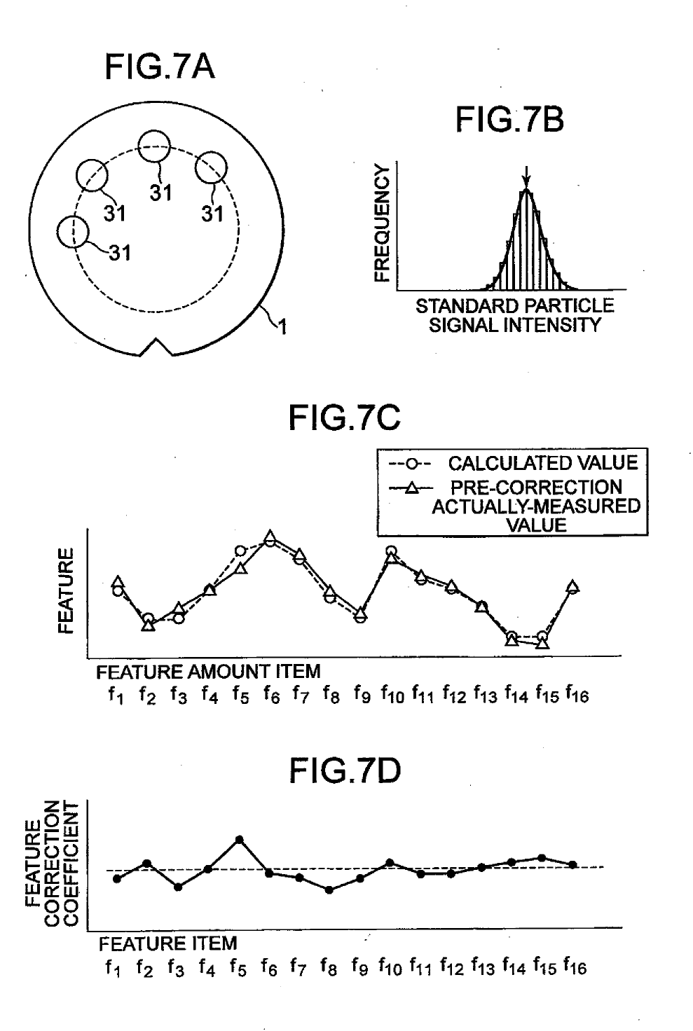

FIG. 7A is a diagram for describing a sample for apparatus calibration. As the sample for the apparatus calibration, there is used one in which scatterers (calibration scatterers) each already known in the quality of material and refractive index are disposed on a sample surface. As the calibration scatterers, spherical particles of polystyrene latex, silica, gold, palladium or the like are used. These are suitable for the calibration scatterers because small-sized standard particles which are ensured in particle diameter and also less reduced in particle-diameter variation, are available, and an ideal scattered light distribution of spherical particles on a flat substrate is obtained by BV method simulation with satisfactory accuracy. A sample to which these particles are adhered using a standard particle spraying apparatus (atomizer) is used as a sample for calibration. A plurality of particle-diameter particles are respectively adhered to positions different from one another. In order to remove the influence of variations in particle diameter, a sample to which a sufficient number of particles (100 or more) are adhered every particle diameter is used. The positions where the particles are disposed may preferably be placed on a concentric circle with the rotational axis of the sample at its rotational scanning being taken as the center as shown as standard particle application regions or areas 31 in FIG. 7A. This is done to avoid variations in the detection condition such as a difference in rotational speed due to radial positions at the sample rotational scanning. There is also an advantage that data for calibration can be obtained in a short period of time by only the rotational scanning and short-distance translational scanning. A histogram of detected signals corresponding to standard particles each having a given particle diameter is shown in FIG. 7B. Even when the particles are identical in particle diameter in terms of specs, each detected signal has variations due to a variation in particle diameter, a variation in the amount of illumination light, scattered light shot noise, a detection-system circuit noise or the like. A typical value (mode, medium or mean) determined from the histogram or the like is used as a signal value of the corresponding particle diameter.

A graph in which a feature calculated from detected signal actually-measured values of scattered light based on the standard particles on the sample for calibration is represented in the form of being superimposed on the calculated values by the BV method simulation, is shown in FIG. 7C. Here, the feature is multidimensional vector quantity calculated at the feature extraction unit 51 based on the scattered light signals detected from the plural detectors of the detection section 102 with respect to the spots judged to be defects at the defect determination unit 50. Since the feature is comprised of scattered light signals in plural directions, they result in amounts with a scattered light distribution of defects reflected thereon. For the comparison with a scattered light distribution library to be described later, values normalized under illumination conditions (illumination intensity, illumination spot size and the like) and detection conditions (quantum efficiency, detection-system bandwidth, amp gain and the like) are calculated. A distribution and quantity of scattered light extremely in the neighborhood of the specularly reflected light measured by the specular reflection detecting unit 104, or the quantity of deflection of the specularly reflected light and the amount of angular expansion are also used as a feature for reflecting defect information. The spatial spread of each defect measured from the spatial profile of the defect detected signals by the method or the like shown in FIG. 6D is also used as a feature. Further, a scattered light signal obtained where the same defect is illuminated under another illumination condition is also used as a feature of the defect. As described above, the number (dimension) of the feature corresponds to the total number of values measured by the detectors 102 and 104. The dimension of feature when measured under a plurality of illumination conditions by scanning of plural times is brought to the product of the total number of the values measured by the detectors 102 and 104 and the number of illumination conditions. However, if only an arbitrary one or a typical value of ones (defect spatial spreads measured by the detectors in the plural directions, for example) substantially non-independent out of these feature items is used, then the dimension of the feature can be reduced without losing the amount of defect information. FIG. 7C is a graphic representation of one example illustrative of the feature set every feature item. The respective feature has shifts or displacements with respect to the ideal value determined by simulation due to individual differences or differences in adjustment between the optical system, detectors and processing circuit of the detection section and the like. Since the feature and actually-measured values determined from the ideal scattered light distribution can be compared using such a calibration sample as described above, such coefficients (refer to an example represented in a graph in FIG. 7D) as to correct the feature in such a manner that they match the ideal value are determined based on them, followed by multiplying the respective feature and actually-measured values by the coefficients, thereby making it possible to reduce errors caused by mounting of the detection system. Since each of the detectors and the processing circuit is considered to have non-linearity, the above calculation of correction coefficients are executed with respect to a plurality of detector/processing circuit parameters (detector sensitivity, gain and processing circuit gain) used on the apparatus according to a plurality of illumination intensities different from one another and standard-sample particle diameters.

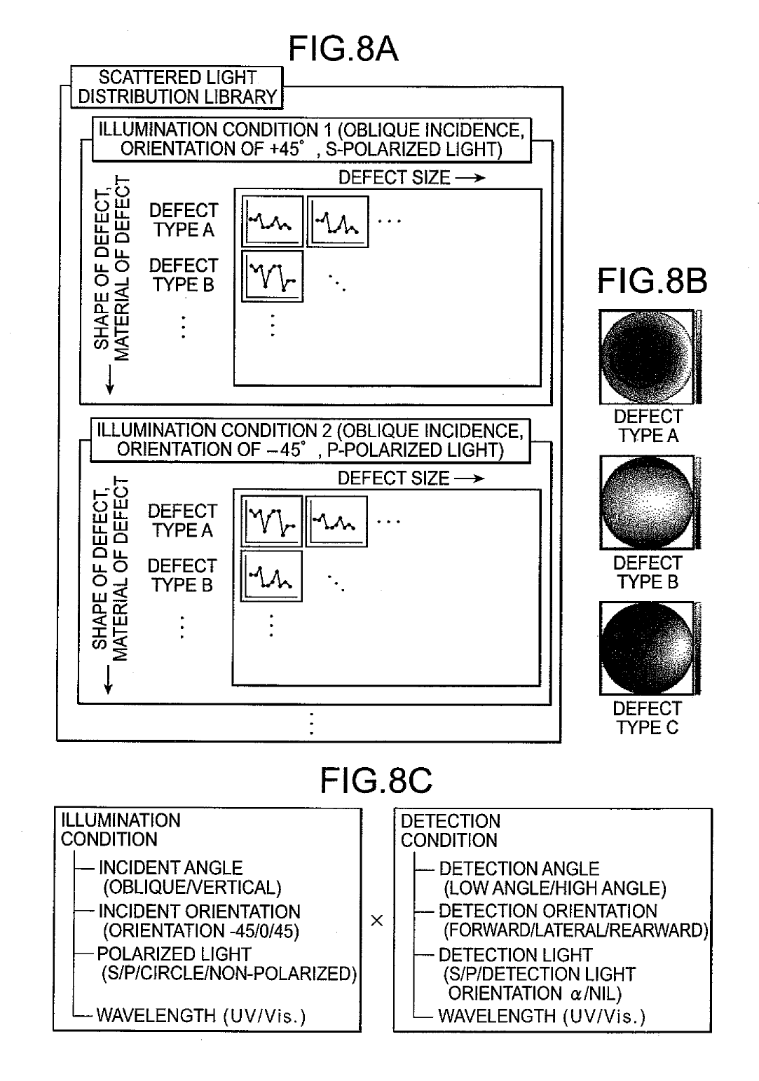

The scattered light distribution library is of a database of defect information, wherein various scattered light distribution data about defects, a feature corresponding to the scattered light distribution data, or a feature (spatial spread of each defect, the quantity of deflection of illumination light due to the surface shape of each defect, etc.) other than the scattered light distribution of each defect are associated with the nature (defect type, quality of material, shape and size) of each defect per se. A typical diagram of a configuration of a scattered light distribution library held in the storage part of the defect type/size determination unit 52 is shown in FIG. 8A. Scattered light distribution data about defects, a feature corresponding to the scattered light distribution data, or a feature (spatial spread of each defect, the quantity of deflection of illumination light due to the surface shape of each defect, etc.) other than the scattered light distribution of each defect under a given illumination condition (illumination condition 1) are held every shape, quality of material and size of each defect. Similar data are held even under other illumination conditions settable on the apparatus. Although FIG. 8A shows the feature of the defects every illumination condition, a data structure in which a feature under a plurality of illumination conditions is held every defect, may be adopted or another classifying method may be taken. Although FIG. 8A shows the discrete feature, data about a continuous scattered light distribution of each defect corresponding to each illumination condition may be held. An example illustrative of continuous scattered light distributions of defects corresponding to illumination conditions is represented in FIG. 8B in the angular notation method shown in FIG. 4A. Parameters indicative of illumination and detection conditions are shown in FIG. 8C. As the illumination condition, may be mentioned, an illumination incident angle, an incident azimuth or orientation, a polarization state and a wavelength with respect to a sample. A combination of the respective parameters becomes one illumination condition. As the detection condition, may be mentioned, a detection angle in a detection direction, a detection orientation, a polarization filtering condition and a wavelength. The number of inspection conditions (combination of illumination and detection conditions) realized by the apparatus results in the product of the number of illumination conditions and the number of detection conditions. Detected signal values at respective inspection conditions realized by the apparatus are held as data for the scattered light distribution library with respect to the respective one of various defects. As for illumination power and detection sensitivity linear in the correspondence with each defect scattered light signal, scattered light detected signals placed under an arbitrary condition are obtained here by multiplying reference normalized scattered light distribution data by suitable coefficients. Therefore, the reference normalized scattered light distribution data may be prepared as to these parameters. Since an influence exerted on the scattered light distribution is non-linear with respect to a change in parameter under such other illumination and detection conditions as shown in FIG. 8C, scattered light distribution data in the respective conditions are prepared in the scattered light distribution library.

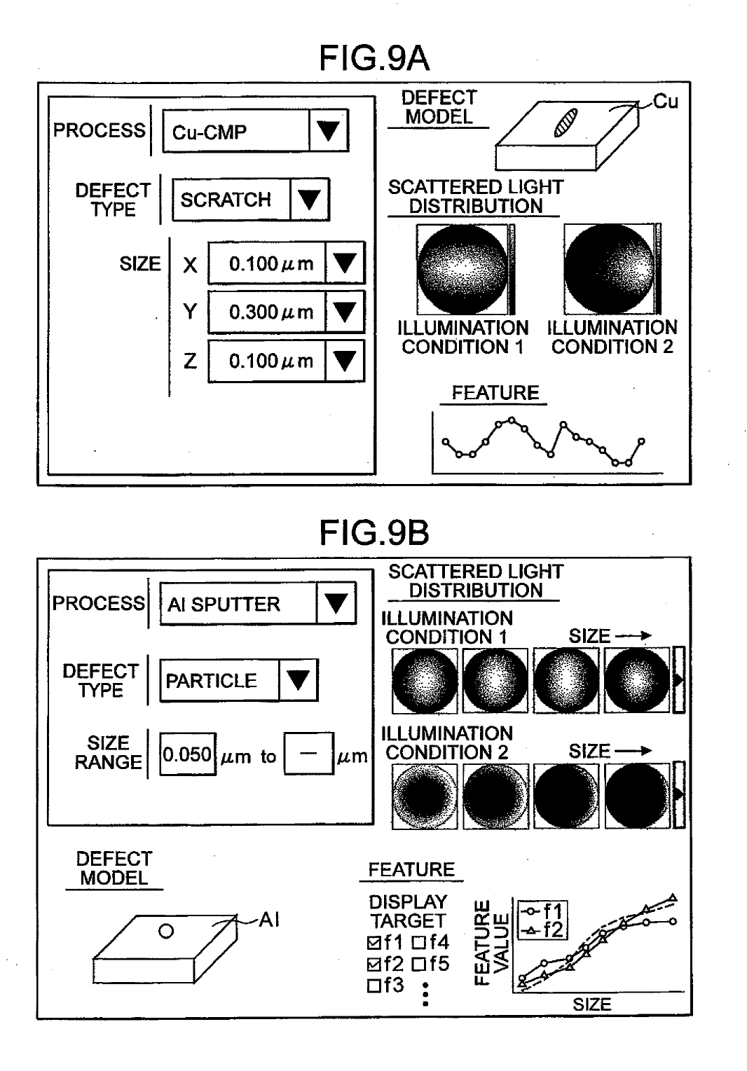

Means for displaying internal data of the scattered light distribution library will be explained using FIG. 9. FIG. 9A is a screen for displaying a model of each individual defect, a scattered light distribution thereof and a feature thereof. They are displayed on the display unit 54, based on the contents inputted from the input unit 55. A process intended for display, defect types and sizes are selected on the display screen of FIG. 9A. The process indicates a process for manufacturing a sample intended for inspection, and the state of the surface of the sample intended for display is selected based on the selection of the process. Although not shown in the drawing, a film structure of the surface of the sample, film type thereof, a refractive index thereof, its thickness, etc. can be selected and set. A defect type intended for display is selected according to the setting of the item of the following defect types. A list of defect types producible at the previous-stage process is displayed in order of the frequency of their occurrence or importance according to the selection of the previous-stage process. The sizes intended for display are selected according to the setting of size items. According to the above settings, a typical diagram of the model of the defect, simulation data about scattered light distributions from the defect and a feature extracted therefrom are displayed on the right side of the display screen in such an embodiment as shown in FIG. 9A. FIG. 9B shows an example of a screen for displaying scattered light distribution data of a size range selected about a specific defect type. The selection of a process and a defect type is common to the contents described in FIG. 9A. The size range intended for display can be selected by the maximum and minimum values. A typical diagram of a defect model, simulation data about scattered light distributions and a feature are displayed according to their settings. The feature represents defect size dependence and the feature intended for display can be selected by a user. The size of a standard particle is also represented together as a target for comparison at the display of the dependence of the feature on the defect size. A detectable minimum defect size can be estimated from a comparison of magnitudes between the standard particle and each signal. Although not illustrated in the drawing, simulation data about a distribution of sample-surface roughness scattered light that impedes a defect detection, can also be displayed. The corresponding simulation data of sample-surface roughness scattered light distribution is displayed by selecting the process and inputting the refractive index of the sample surface, its roughness (RMS, Ra), a spatial frequency distribution and the like as needed.

The user of the apparatus is able to confirm data contents contained in the scattered light distribution library using the above display means and input means. The displayed contents are set and changed according to the input of the user. The user is able to optimize inspection conditions (illumination intensity, illumination incident angle, illumination polarization, detection direction, polarization filtering, detector sensitivity), the selection and weighting of a detector signal used for defect determination, a targeted defect type and a size range, and the selection and weighting of a detector signal used for determination of each defect type and size, based on the displayed contents.

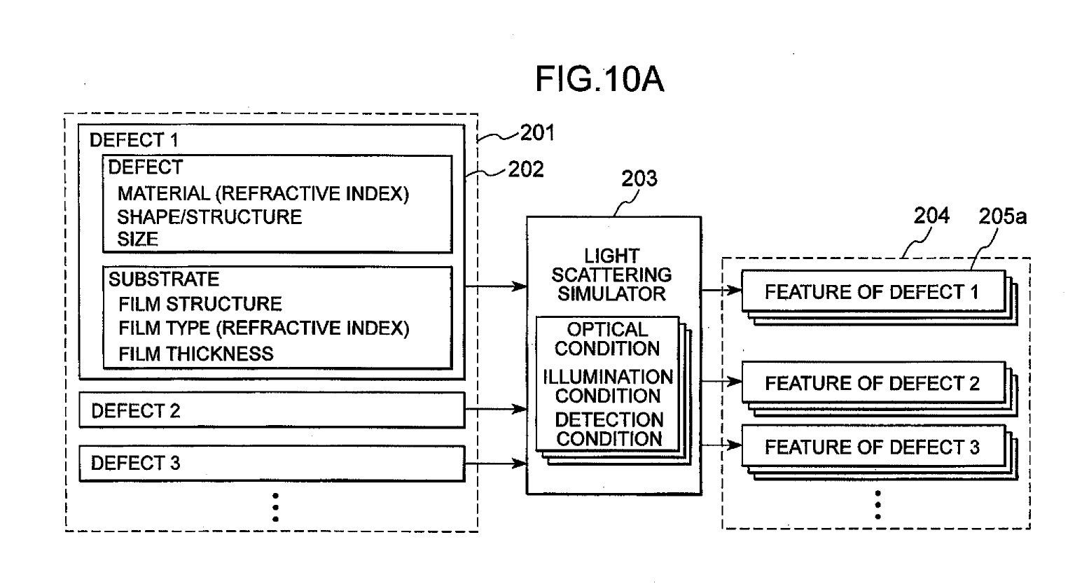

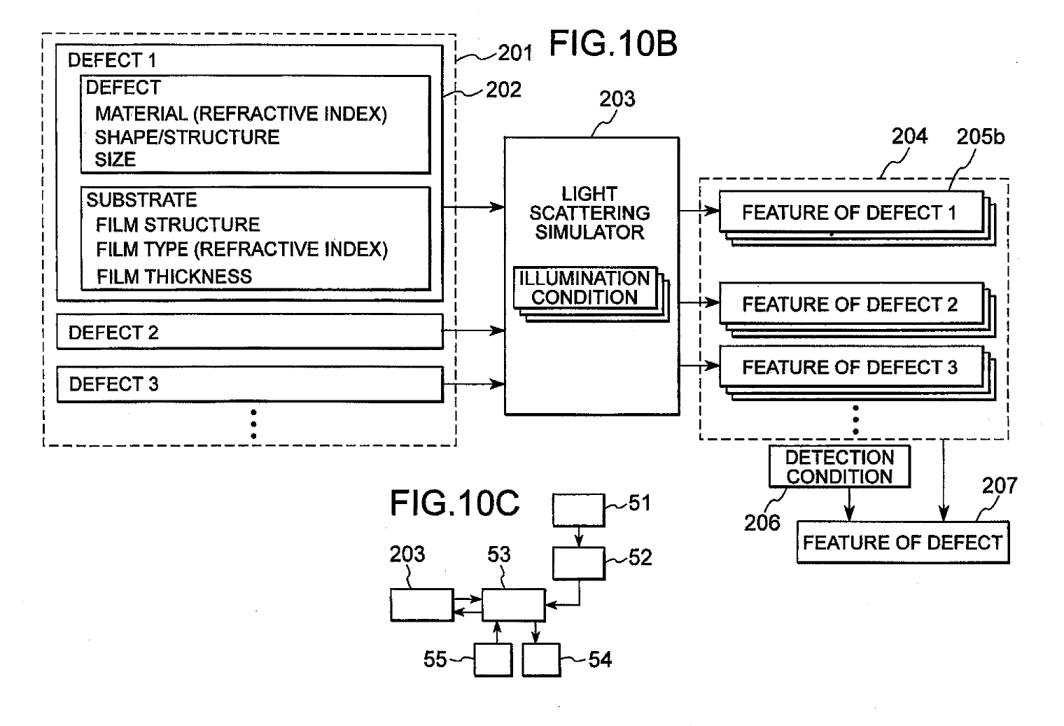

A description will be made of means for creating a scattered light distribution library and its configuration using FIG. 10A. A defect set 201 comprises various defect data 202 in various processes. The defect data 202 correspond to information (quality of material, shape and size) of each defect and information (film structure, film type and film thickness) of a substrate (sample surface on which each defect exists), i.e., input parameters to simulation that represents a corresponding defect simulation model. In addition to the defect data 202, optical conditions (illumination condition and detection condition) provided in the apparatus are inputted to a light scattering simulator 203, where simulation is done. Feature 205a detected and extracted under the optical conditions provided in the apparatus every defect data is obtained by processing the result of simulation, so that a scattered light distribution library 204 is created. FIG. 10B shows an embodiment in which scattered light distributions 205b of defects are brought to a scattered light distribution library. In the embodiment of FIG. 10B, a light scattering simulator 203 outputs scattered light distributions produced from the defects, based on defect data 202 and illumination conditions provided in the apparatus. They are held on the apparatus as a scattered light distribution library. The present embodiment has advantages that a feature corresponding to an arbitrary detection condition can be calculated based on each scattered light distribution, and the scattered light distribution library per se needs not to be modified even where the detection condition provided in the apparatus is changed. On the other hand, the embodiment of FIG. 10A has an advantage that since only the feature 205a corresponding to the detection conditions provided in the apparatus may be held, less storage capacity is taken. The scattered light distribution library created as descried above is held in the storage part of the defect type/size determination unit 52. A block diagram showing a configuration of a defect inspection apparatus with a light scattering simulator built therein is shown in FIG. 10C. Only a portion related directly to a defect type/size determining process is illustrated herein. A light scattering simulator 203 is connected to an overall control unit 53. When an input condition for light scattering simulation is inputted from an input unit 55, light scattering simulation is carried out and the result of simulation, i.e., a defect scattered light distribution is added to its corresponding scattered light distribution library contained in a defect type/size determination processing unit. The simulation result is also displayed on a display unit 54. The light scattering simulator is equivalent to one in which an FEM method, an FDTD method, a DDA method or a BV method used as a simulation method or technique is implemented as a calculation program. A plural or any one of these methods is mounted in the light scattering simulator. When the plural methods are mounted therein, suitable methods are selected according to targets for calculation, for instance, the BV method is selected for spherical particles on a substrate, the DDA method is selected in the case of isolated defects on or inside the substrate, and the FEM method or FDTD method is selected in the case of defects each having a more complicated shape or pattern defects.

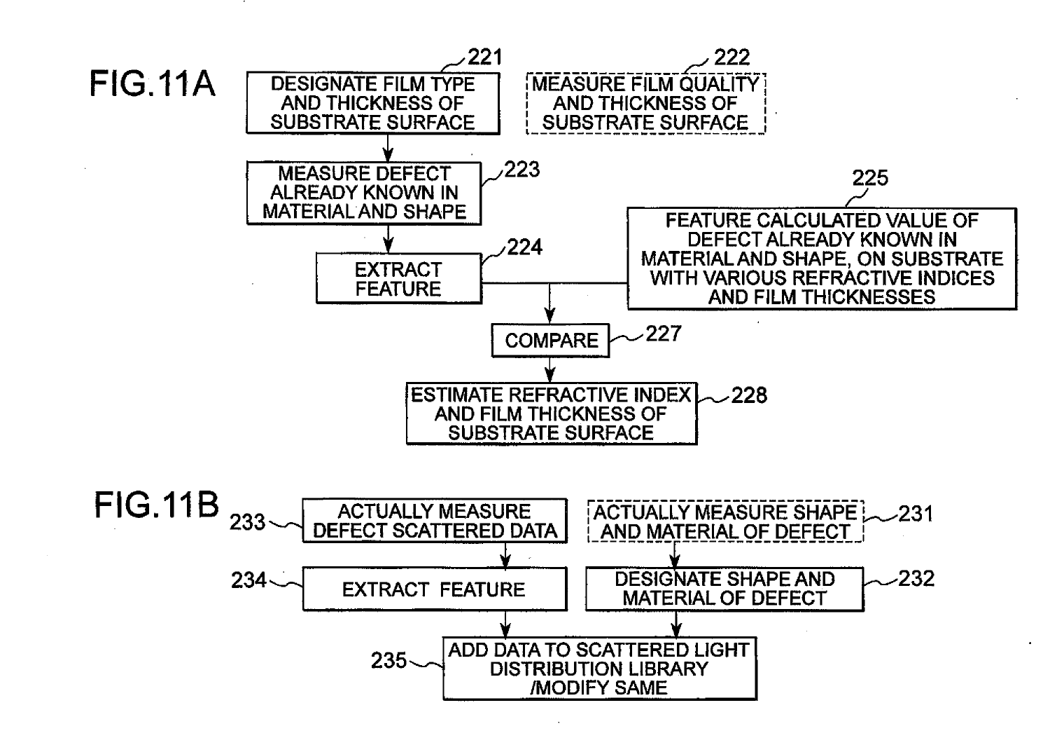

FIG. 11A is a diagram showing a substrate refractive index estimating method for performing high precision defect type classification and size determination. A scattered light distribution of defects changes depending on a refractive index of a substrate surface. Since, however, the refractive index on the substrate surface depends on a substrate's manufacturing condition like a deposition condition or the like even if the same quality of material is taken, a constant value is not necessarily adopted. Thus, the refractive index of the substrate intended for inspection is actually recognized in advance with satisfactory accuracy. In doing so, the accuracy of both determination of each defect type and determination of each size, which are to be described later, is improved. Therefore, film type and thickness of a sample intended for inspection are first designated by input means to be described later (Step 221). Next, a scattered light distribution of each defect already known in material and shape as in the above-described standard particle is measured (Step 223), and a feature is extracted (Step 224). On the other hand, a feature calculated value (Step 225) of each defect already known in material and shape, on the substrate having various refractive indices is held in its corresponding scattered light distribution library. This is compared with the feature extracted at Step 224 (Step 227). The film type and thickness of the substrate surface can be estimated by specifying the substrate refractive index and thickness each having the feature calculated value close to an actually-measured value (Step 228). Incidentally, if the configuration of the specular reflection detection unit 104 described in FIG. 5C has been provided, then the material (refractive index) of the film of the substrate surface and its thickness can be directly measured (222) and are available.

A method for modifying or correcting a scattered light distribution library based on actually-measured values or a data adding method will be explained using FIG. 11B. A targeted defect is first inspected or examined (Step 233), and a feature is extracted (Step 234). The shape of each defect is measured in advance using measuring means such as SEM (Scanning Electron Microscopy), TEM, AFM (Atomic Force Microscopy) or the like (Step 231). The so-obtained measured value is inputted (Step 232) and held in the corresponding scattered light distribution library with being associated with an actually-measured value of each feature, thereby making it possible to add defect's data unheld in the scattered light distribution library. When the corresponding already-existing defect data exists, the data is modified with being overwritten with the already-existing defect data.

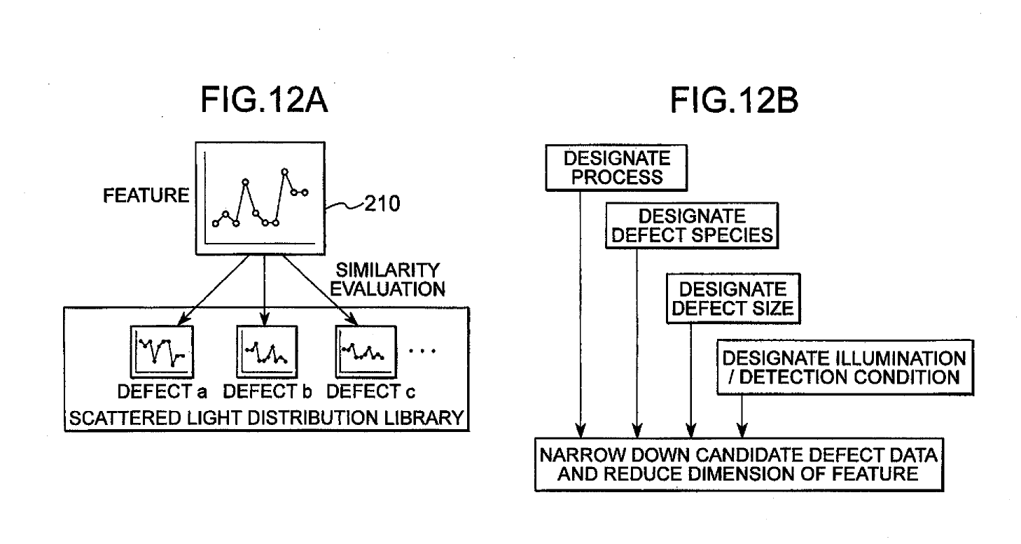

A method for determining a defect type and a defect size, based on each feature extracted at the feature extraction unit 51 by the defect type/size determination unit 52 will be explained using FIG. 12A. The feature 210 extracted at the feature extraction unit 51 with respect to each detected defect is compared with each defect contained in the corresponding scattered light distribution library. A defect type and a defect size most analogous to the feature 210 are determined to be a defect type of the detected defect and a defect size thereof. Defect data compared with the feature 210 is of partial defect data narrowed down from the corresponding scattered light distribution library. This will be called “candidate defect data” here. The similarity between the feature 210 and the feature of each candidate defect data is evaluated, and defect data brought to the maximum similarity is outputted as the result of determination. Interpolation thereof is performed based on a plurality of defect data high in similarity to determine a defect size, thereby enhancing the resolution of defect size determination.

As an example of an index for the similarity of each feature, the inverse or inverse number of a distance between two features is used. Assuming that the dimension of the feature is N, the distance (Euclidean distance) L between a feature Fa=(fa1, fa2, . . . , faN) and a feature Fb=(fb1, fb2, . . . , fbN) is defined by L=(fa1−fb1)̂2+(fa2−fb2)̂2+ . . . +(faN−fbN)̂2 (where â2 indicates the square of a). A calculated amount is reduced by using a Manhattan distance L=|fa1−fb1|+|fa2−fb2|++|faN−fbN| as the distance L. A weighted distance L′ weighted according to the reliability of the feature 210=w1 (fa1−fb1)̂2+w2 (fa2−fb2)̂2+ . . . +wN (faN−fbN)̂2 can also be defined. Since the amount of each dimension of the feature 210 has a variation, the inverse of its variation is defined as a weighting factor wN. Since the variation is caused by each of scattered light shot noise and circuit noise, it can be calculated from the detection condition and the intensity of each detected signal.

A method for narrowing down candidate defect data intended for feature comparison from within a scattered light distribution library will be explained using FIG. 12B. A process intended for inspection, a defect type and a defect size are designated by means to be described later. The defect data is narrowed down to only defect data of a substrate (film structure, film type and film thickness) corresponding to the designated process, based on the designation of the process. When a decision as to only whether or not the defect type belongs to a specific defect series is made according to the designation of each specific type, the evaluation of similarity is performed with only the designated defect type being targeted for comparison, whereby only one that exceeds a similarity decision threshold value designated by predetermined or after-mentioned means is determined to be the defect type. The defect size is also similar to the designation of the defect type. Since the feature of the scattered light distribution library corresponds to all illumination detection conditions provided in the apparatus, the feature t is narrowed down to one related to the illumination/detection conditions at the inspection, thereby making it possible to cut down the dimension of each feature and reduce a calculated amount.

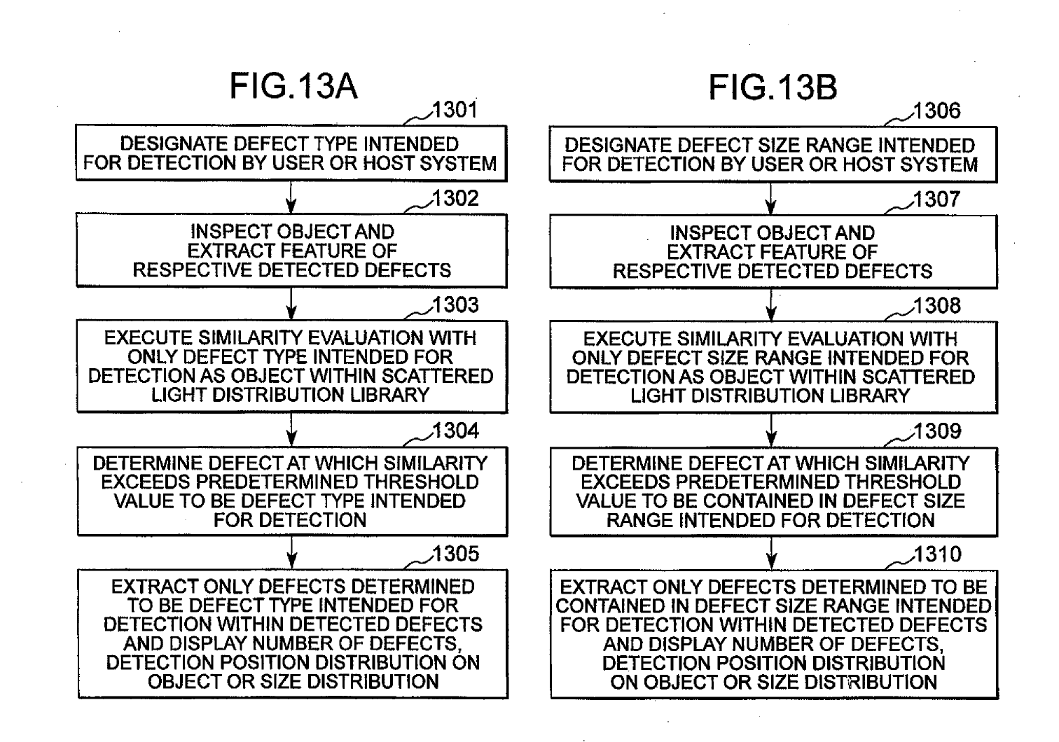

An input/output flow used where a defect type intended for inspection is designated is shown in FIG. 13A. An input/output flow used where a defect size is designated is shown in FIG. 13B. When a user specifies or designates a defect type intended for inspection through input means to be described later (Step 1301), the corresponding object is inspected and a feature of each detected defect is extracted (Step 1302). Thereafter, a similarity evaluation is done with only the defect type intended for detection being taken as an object within a scattered light distribution library (Step 1303). Each defect at which the similarity exceeds a predetermined threshold value is determined to be the defect type intended for detection (Step 1304). Only each defect judged to be the defect type intended for detection within the detected defects is extracted. The number of the defects, a detection position distribution (defect map) on the object or a size distribution is displayed on the display unit 54 (Step 1305). On the other hand, when the user designates a defect size range intended for inspection through the input means to be described later (Step 1306), the corresponding object is examined and a feature of each defect detected is extracted (Step 1307). Thereafter, a similarity evaluation is executed with only a defect size range intended for detection being taken as the object within the scattered light distribution library (Step 1308). It is determined that each defect at which the similarity exceeds a predetermined threshold value is contained in the defect size range intended for the detection (Step 1309). Only each defect judged to be contained in the defect size range intended for detection is extracted within the detected defects. The number of the defects, a detection position distribution (defect map) on the object or a size distribution is displayed on the display unit 54 (Step 1310).

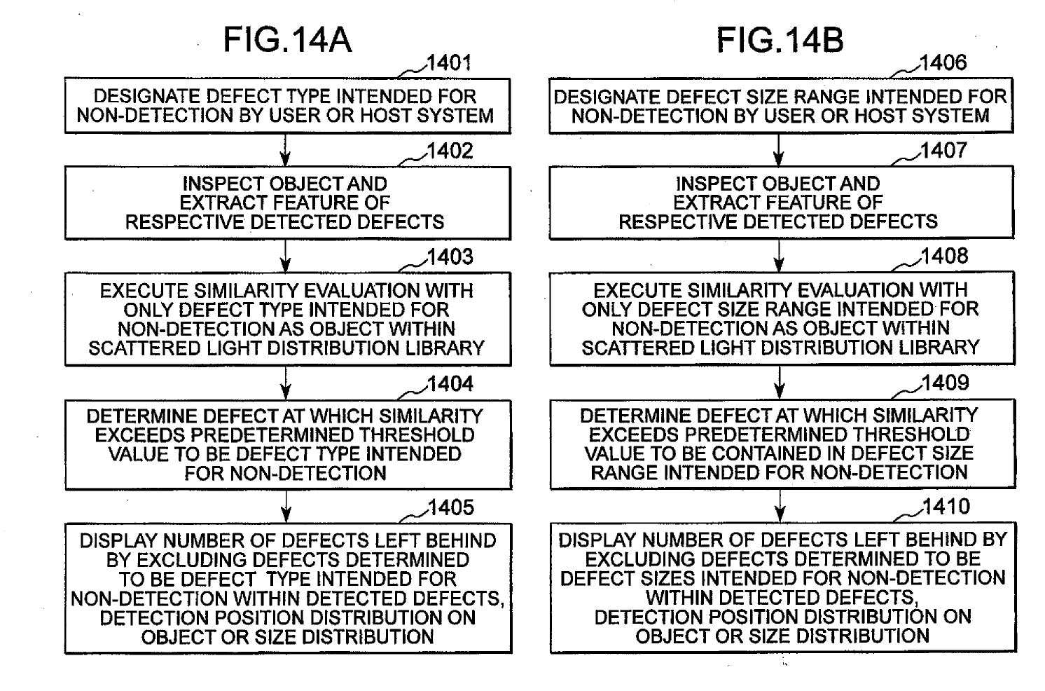

Next, an input/output flow used where a defect type excluded from an object to be examined is designated, is shown in FIG. 14A. An input/output flow used where a defect size is designated is shown in FIG. 14B. When the user specifies or designates a defect type (excluded from an object to be examined) intended for non-inspection through input means to be described later (Step 1401), the corresponding object is inspected and a feature of each defect detected is extracted (Step 1402). Thereafter, a similarity evaluation is executed with only a defect type intended for non-detection being taken as an object within a scattered light distribution library (Step 1403). Each defect at which the similarity exceeds a predetermined threshold value is determined to be the defect type intended for non-detection (Step 1404). Only each defect left behind by excluding each defect judged to be the defect type intended for non-detection out of the detected defects is extracted. The number of the defects, a detection position distribution (defect map) on the object or a size distribution is displayed on the display unit 54 (Step 1405). On the other hand, when the user designates a defect size range intended for non-inspection through the input means to be described later (Step 1406), the corresponding object is examined and a feature of each defect detected is extracted (Step 1407). Thereafter, a similarity evaluation is executed with only the defect size range intended for non-detection being taken as the object within the scattered light distribution library (Step 1408). It is determined that each defect at which the similarity exceeds a predetermined threshold value is contained in the defect size range intended for the non-detection (Step 1409). Only each defect left behind by excluding each defect judged to be contained in the defect size range intended for non-detection within the detected defects is extracted. The number of the defects, a detection position distribution (defect map) on the object or a size distribution is displayed on the display unit 54 (Step 1410).

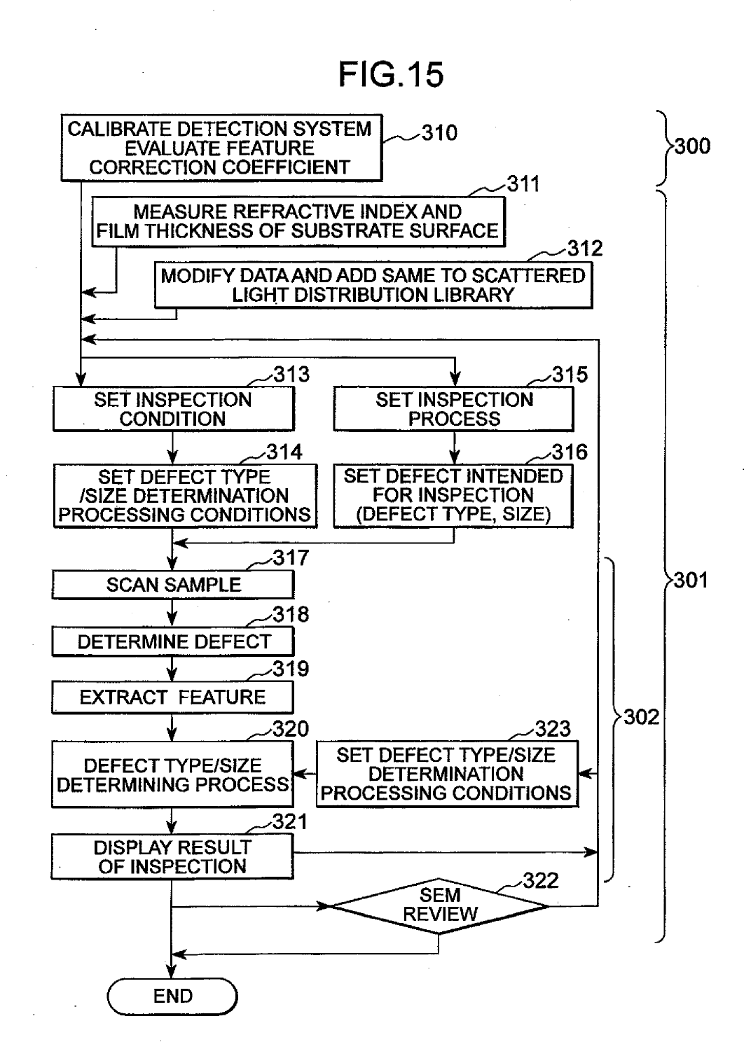

An inspection flow will be explained using FIG. 15. The inspection flow shown in FIG. 15 is divided into a flow 300 executed at an adjustment stage at the introduction of the apparatus and at the regular calibration and adjustment, a flow 301 executed where the apparatus is applied to a novel process and where a target, sensitivity and the like to be inspected are changed, and a flow 302 repeatedly executed with a large number of samples as objects with respect to a process at which inspection has already been done, and a process at which an inspection condition is already known. At the adjustment stage at the introduction of the apparatus and upon the regular calibration and adjustment, the illumination unit, detection unit and processing unit calibrate sensitivity and an input-output response separately respectively. Thereafter, a feature correction coefficient for correcting an error of the entire detection system is determined using the method shown using FIG. 7 and applied to the feature extraction unit 51 (Step 310). When the apparatus is applied to the novel process and the process condition prior to the process intended for inspection is changed, the refractive index and film thickness of the substrate surface are actually measured as needed by the method or the like described using FIG. 11A, and their values are set upon process designation to be described later (Step 311). When a novel defect type is taken as intended for detection, the addition of data to the corresponding scattered light distribution library or the modification thereof is performed as needed by the method described using FIG. 11B (Step 312). It is thus possible to perform the measurement and the comparison of each extracted feature with the data of the scattered light distribution library with high accuracy by the apparatus. Next, the setting of the detection condition and the setting of defect type/size determination processing conditions are carried out by the input from the user (Steps 313 and 314). The past conditions held in the apparatus can be set to each process already subjected to the inspection. Here, the inspection conditions indicate conditions for illumination, detection and signal processing and contain a set of plural illumination conditions different from one another. The illumination, detection and signal processing may not necessarily be inputted directly upon the designation of the inspection condition. Conditions under which a high SN ratio, high precision classification or a high precision size measurement is expected may be estimated and set by computer processing, based on the process intended for inspection and the input of setting of defects (defect type and size) intended for inspection using information about a scattered light distribution library and information about substrate surface roughness scattering (Steps 315 and 316). A sample is scanned under the set inspection conditions (Step 317) and hence a defect decision is made (Step 318).

And a feature is extracted (Step 319). A defect type and a defect size are determined by the above method using the extracted feature (Step 320). The result of inspection is displayed based on the output corresponding to the result of determination (Step 321). Whether the result of inspection meets an inspection purpose is determined after defect review (Step 322) using a defect review SEM or the like has been carried out as needed. When it is found not to meet the inspection purpose, the inspection condition is changed and rescanning is performed. When the lack of accuracy and a misdecision occur in the determination of each defect type and size determination processing although the defects have been detected, the setting of the defect type/size determination processing conditions is changed (Step 323), and the reprocessing of defect type/size determination is performed on the feature of each defect, which has already been acquired and detected. When it is difficult to perform the defect type/size determination that meets the precision required, by only the already-captured feature, the inspection condition is changed and re-inspection is performed.

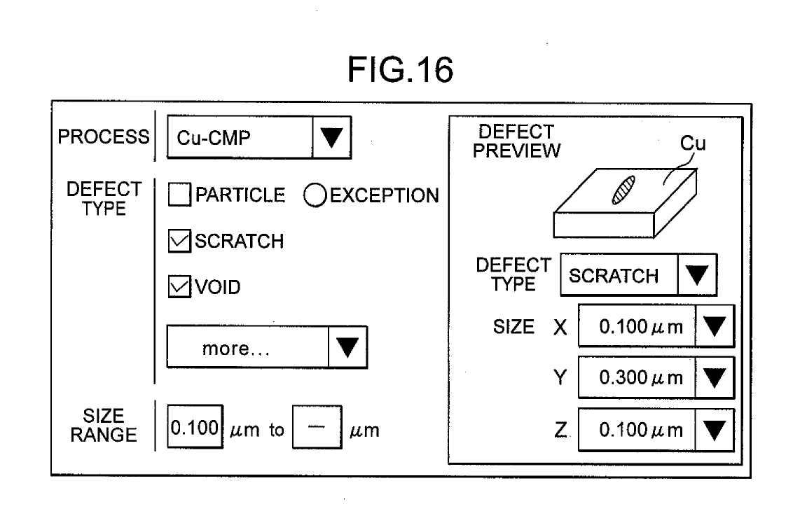

FIG. 16 shows an example of a GUI (Graphical User Interface) for setting an inspection process, defects intended for inspection and a size intended for inspection. A process intended for inspection or to be inspected can be selected from within process choices held in the apparatus and inputted. The process is associated with substrate information (film structure, film type and film thickness) of defect data in a scattered light distribution library. Although not shown in the figure, a film structure, film type, refractive index and film thickness of a sample surface can be selected and set directly. A defect type intended for inspection is selected according to the setting of the items of the defect type. According to the selection of the pre-stage process, a list of defect types likely to occur in that process is represented in order of the frequency of their occurrence or importance. It is also possible to select each non-displayed defect type from within the scattered light distribution library. A defect type (defect type intended for non-inspection) excluded from the object to be examined can also be set. A plurality of defect types can be selected and set. As upper and lower limits of a size range intended for inspection can be inputted and set respectively. An example of a defect model of a selected defect type is displayed on a defect preview on the right side of FIG. 16. Each object to be displayed can be selected and changed.

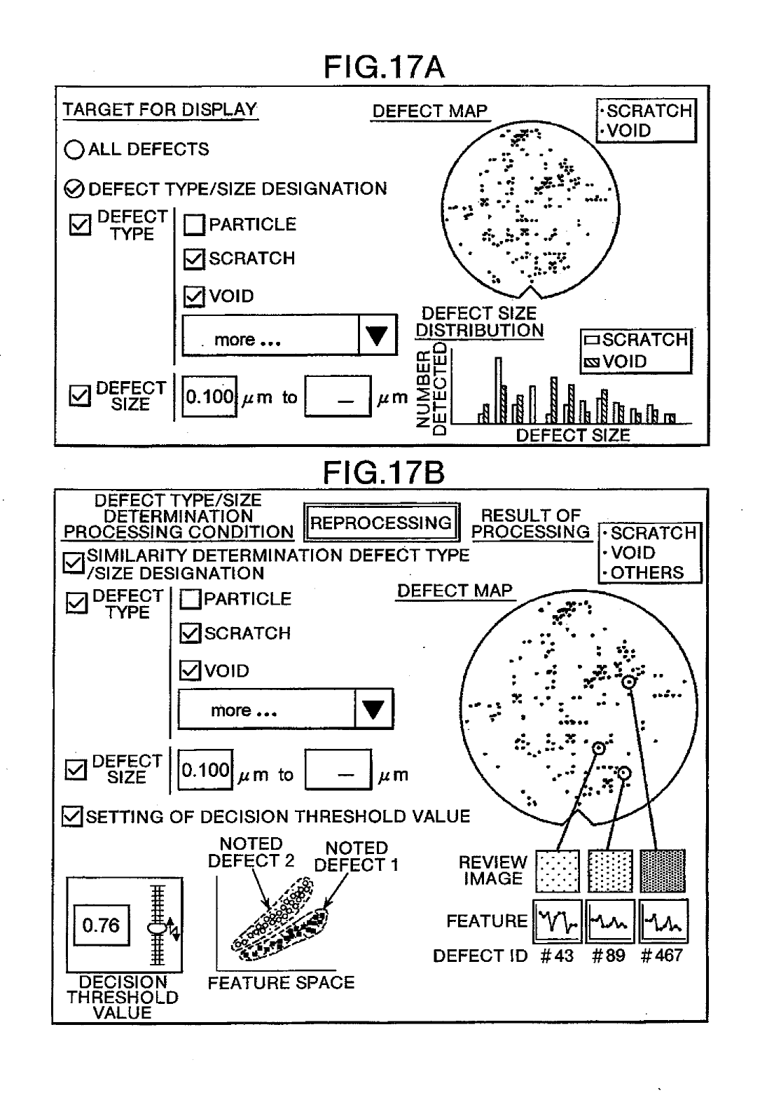

FIG. 17A shows an example of a GUI indicative of a result of inspection. It is possible to select whether a range intended for display should be narrowed down to all defects, a designated defect type or a defect size range. A defect type and a defect size intended for display can be inputted and set by the GUI in a manner similar to FIG. 16. The result of inspection is represented in the form of a defect map and a defect size distribution. The defect map and the defect size distribution are both represented in such a state that defect type-specific distributions can visually be grasped according to differences among colors, data point shapes, graphic forms, graph hatching, etc. FIG. 17B shows an example of a GUI for performing the setting of each defect type and a size determination processing condition and the display of the result of processing after a target sample has been scanned at least once or more. This GUI enables the setting of a decision threshold value used for the designation of defect types and sizes intended for similarity determination (the above designation of candidate defect data) and the determination as to whether they are contained in the target defect type and the defect size range. The setting of the decision threshold value can be adjusted while looking at the corresponding distribution on space for the already-acquired feature. The distribution of the acquired feature on the feature space can be displayed in conjunction with a feature distribution of defect data contained in a scattered light distribution library within a one, two or three dimensional feature space. Only a detected defect designated can be represented by pointing a defect map or the like. Here, as to the defect data contained in the scattered light distribution library, only ones contained in the designated candidate defect data range will be intended for display. The decision threshold value can be changed by moving a slider up and down or directly inputting numerical values. The influence of a change in the threshold value is represented in real time as changes in region form and area around the candidate defect data at the feature space representation (regions surrounded by dotted lines of feature space graphs in FIG. 17B). After the defect type/size determination processing conditions have been changed by the above GUI, reprocessing can be performed on the already-acquired feature under post-change processing conditions. The result of reprocessing is displayed as a defect map capable of grasping distributions set every defect type as shown on the right side of FIG. 17B immediately after completion of reprocessing. Such a defect map that approximate defect sizes brought or taken every defect are recognized in place of the defect type can also be displayed. Review images of defects on the defect map and the already-acquired feature can be displayed in association with one another with respect to the defects on the defect map. The acquired feature can also be displayed in conjunction with defect feature data of a scattered light distribution library, determined to be similar thereto by reprocessing. As described above, the proposal of conditions or requirements for defect type/size determination processing can be carried out while actual defect types and sizes are being confronted against the result of determination.

While the invention made above by the present inventors has been described specifically on the basis of the preferred embodiments, the present invention is not limited to the embodiments referred to above. It is needless to say that various changes can be made thereto within the scope not departing from the gist thereof.

According to the present invention, high precision defect classification and a high precision defect size measurement can be performed on each defect that exists in the surface of a sample.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A defect inspection apparatus comprising:
an illumination section for introducing light emitted from a light source onto a sample;
a detection section for detecting scattered light components scattered in plural directions different from one another, of scattered light from the sample by illumination of the illumination section and outputting a plurality of detected signals corresponding to the detected scattered light components;
a signal processing section for extracting multidimensional features corresponding to defects using the detected signals and comparing the multidimensional features and pre-stored scattered light distribution data thereby to determine the types and sizes of the defects; and
a display unit for displaying a result of determination by the signal processing section.

2. The defect inspection apparatus according to claim 1, wherein the signal processing section includes a defect determination unit for processing the detected signals thereby to determine the presence of the defects, and a feature extraction unit for outputting the multidimensional features corresponding to the defects determined by the defect determination unit.

3. The defect inspection apparatus according to claim 1, wherein the scattered light distribution data are selected from a scattered light distribution library corresponding to a set of scattered light distribution data about defects of a plurality of types and a plurality of sizes pre-stored in a storage unit of the signal processing section.

4. The defect inspection apparatus according to claim 1, wherein the detection section has a plurality of detectors for collectively detecting scattered light components scattered in plural directions different from one another, of scattered light from the sample.

5. The defect inspection apparatus according to claim 1, wherein the signal processing section corrects the multidimensional features using correction coefficients calculated in advance.

6. The defect inspection apparatus according to claim 5, wherein the correction coefficients are calculated by detecting scattered light of scatterers already known in refractive index and shape and comparing a feature calculated from acquired detected signal actually-measured values and a feature determined by simulation.

7. The defect inspection apparatus according to claim 1, wherein the display unit displays the detected number of defect types selected by a user or at least one of distributions on the sample.

8. A defect inspection apparatus comprising:
an illumination section for introducing light emitted from a light source onto a sample;
a detection section for detecting a plurality of scattered light components emitted in plural directions different from one another, of scattered light produced on the sample by illumination of an illumination optical unit in the illumination section and outputting a plurality of detected signals corresponding thereto;
a defect determination unit for processing the detected signals outputted from the detection section to determine the presence of defects;
a feature extraction unit for outputting multidimensional features corresponding to the defects determined at the defect determination unit, based on the detected signals;
a storage unit for holding a scattered light distribution library corresponding to a set of scattered light distribution data about defects of plural types and sizes;
a defect type/size determination unit for determining the types and sizes of defects by comparison between the feature and the scattered light distribution library; and
a display unit for displaying a result of classification and a result of size determination obtained at the defect type/size determination unit.

9. The defect inspection apparatus according to claim 8, wherein a detection optical unit in the detection section collectively detects defect scattered light scattered in plural directions using a plurality of detectors.

10. The defect inspection apparatus according to claim 8, wherein the detection optical unit corrects each of the feature outputted from the feature extraction unit, based on the magnitude of each of signals obtained by detecting scattered light of scatterers already known in refractive index and shape.

11. The defect inspection apparatus according to claim 8, wherein the storage unit corrects each of the scattered light distribution data, based on the magnitude of each of scattered light detected signals of the scatterers already known in refractive index and shape, which are obtained at the detection optical unit, the material of a film of a substrate surface or the thickness of the film of the substrate surface.

12. The defect inspection apparatus according to claim 8, further including an input unit capable of inputting each defect type intended for detection by a user,
wherein the display unit displays the detected number of only defect types each designated as the defect type intended for the detection, of those determined to be defective at the defect determination unit, or a distribution on each object to be inspected.

13. The defect inspection apparatus according to claim 8, further including an input unit capable of inputting each defect type intended for non-detection by a user,
wherein the display unit displays the detected number of defect types excepting defect type each designated as the defect type intended for the non-detection, of those determined to be defective at the defect determination unit, or a distribution on each object to be inspected.

14. The defect inspection apparatus according to claim 12, wherein the display unit displays a typical diagram of a shape of each of defects each belonging to the defect type designated at the input unit, an enlarged image thereof by an electron microscope or the like, a scattered light distribution thereof or a feature corresponding to the scattered light distribution.

15. A defect inspection method comprising the steps:
an illumination step for introducing light emitted from a light source onto a sample;
a detection step for detecting a plurality of scattered light components emitted in plural directions different from one another, of scattered light produced on the sample in the illumination step and outputting a plurality of detected signals corresponding thereto;
a defect determination step for processing the detected signals obtained in the detection step to determine the presence of defects;
a feature extraction step for outputting multidimensional features corresponding to the defects determined in the defect determination step, based on the detected signals;
a defect type/size determination step for determining the types and sizes of the defects by comparison between a scattered light distribution library corresponding to a set of scattered light distribution data about defects of a plurality of types and a plurality of sizes held in advance and the feature; and
a display step for displaying a result of classification and a result of size determination obtained in the defect type/size determination step.

16. The defect inspection method according to claim 15, wherein in the detection step, defect scattered light scattered in plural directions are collectively detected.

17. The defect inspection method according to claim 15, wherein each feature outputted in the feature extraction step is corrected based on the magnitude of each of detected signals obtained by detecting scattered light of scatterers already known in refractive index and shape in the detection step.

18. The defect inspection method according to claim 15, wherein in a storage step after the steps above, each of the scattered light distribution data is corrected based on the magnitude of each of scattered light detected signals of the scatterers already known in refractive index and shape, which are obtained in the detection step, the material of a film of a substrate surface or the thickness of the film of the substrate surface.

19. The defect inspection method according to claim 15, further including an input step for enabling a user to input each defect type intended for detection,
wherein in the display step, the detected number of only defect types each designated as the defect type intended for the detection, of those determined to be defective in the defect determination step, or a distribution on each object to be inspected is displayed.

20. The defect inspection method according to claim 15, further including an input step for enabling a user to input each defect type intended for non-detection,
wherein in the display step, the detected number of defect types excepting defect types each designated as the defect type intended for the non-detection, of those determined to be defective in the defect determination step, or a distribution on each object to be inspected is displayed.
